(19) United States
(12) Patent Application Publication
(10) Pub. No.: US 2026/0017168 A1
(43) Pub. Date: Jan. 15, 2026

(54) LEVERAGING TEMPORAL CONTEXT DATA FOR SYSTEM ALERT MESSAGES

(71) Applicant: Dell Products, L.P., Round Rock, TX (US)

(72) Inventors: Corinne Schulze, Hopkinton, MA (US); Ming Qian, Newton, MA (US); Michael Barnes, Doylestown, PA (US); Sumanta Kashyapi, Worcester, MA (US); Ramesh Doddaiah, Westborough, MA (US)

(21) Appl. No.: 18/770,891

(22) Filed: Jul. 12, 2024

(51) Int. Cl. G06F 11/34; G06F 11/30

(52) U.S. Cl. CPC G06F 11/3476; G06F 11/3075; G06F 2201/81

(57) ABSTRACT

Architectures and techniques are described that can encode temporal context into a prompt and/or a soft prompt associated with a natural language artificial intelligence (AI) model such as a large language model (LLM). For example, a group of alert messages generated by a rules-based engine can be received. Based on timestamp data associated with the alert messages temporal context can be retrieved from telemetry store or another store with time series data and/or temporal context data. The temporal context can be encoded into an embedding layer of the AI model that is configured to receive input according to a text modality rather than a temporal modality.

### BACKGROUND

In the context of a data services platform, proactive maintenance of servers and storage devices is relied upon to ensure continuous availability of business applications. To facilitate early detection of abnormal behavior and/or anomalous behavior in a system of the data services platform, various alert mechanisms are deployed to promptly notify users and system administrators about specific anomalies or abnormalities. These alert mechanisms are intended to enable preemptive measures to be taken in order to mitigate the impact of service disruptions or avoid the service disruptions altogether.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating an example data services platform with a health monitoring system that generates alerts in accordance with certain embodiments of this disclosure;

FIG. 2 depicts a schematic block diagram illustrating an example prompt builder that can encode temporal context into a prompt associated with a natural language AI model in accordance with certain embodiments of this disclosure;

FIG. 3 depicts a schematic block diagram illustrating temporal prompt chaining that integrates the temporal context in accordance with certain embodiments of this disclosure;

FIG. 4 depicts a schematic block diagram illustrating in more detail operation of the time series soft prompt encoder 208 in accordance with certain embodiments of this disclosure;

FIG. 5 depicts a schematic block diagram illustrating an example device that can perform temporal embedding that encodes temporal context data into an embedding layer of an AI model in accordance with certain embodiments of this disclosure;

FIG. 6 depicts a schematic block diagram illustrating additional aspects or elements of the example device that can perform temporal embedding that encodes temporal context data into an embedding layer of an AI model in accordance with certain embodiments of this disclosure;

FIG. 7 illustrates an example method that can perform temporal embedding that encodes temporal context data into an embedding layer of an AI model in accordance with certain embodiments of this disclosure;

FIG. 8 illustrates an example method that can provide for additional elements or functionality relating to temporal embedding that encodes temporal context data into an embedding layer of an AI model in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

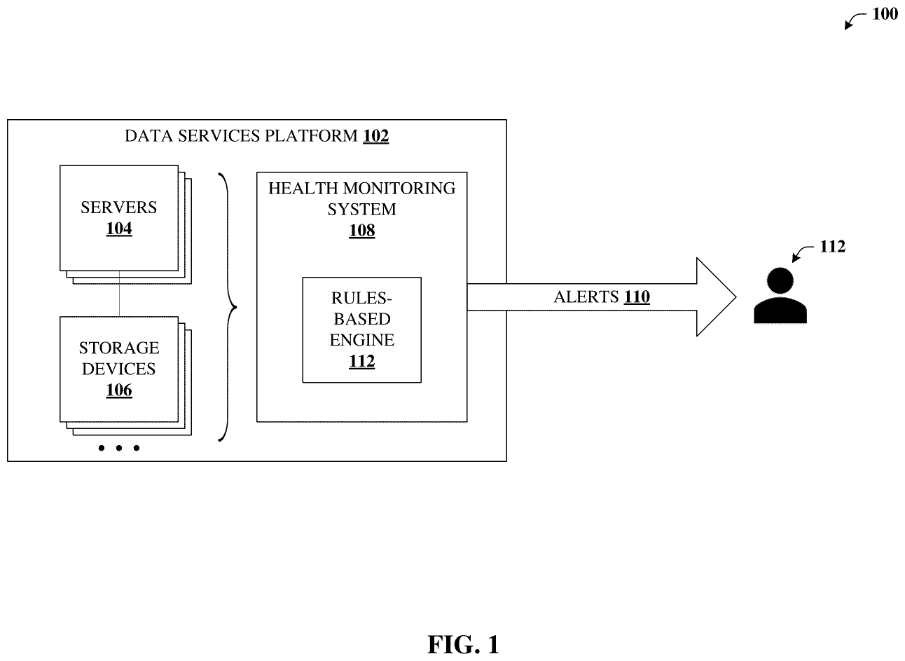

To provide additional context, consider FIG. 1. FIG. 1 shows a schematic block diagram 100 illustrating an example data services platform 102 with a health monitoring system 108 that generates alerts 110 in accordance with certain embodiments of this disclosure.

Data services platform 102 can be any suitable infrastructure that can enable the storage, management, and/or retrieval of data. Data services platform 102 can comprise one or more servers 104. For example, a server 104 can be a specialized computer that provides computing resources such as processing power, memory, or storage in order to, e.g., support data processing and data management. Servers 104 can be physical servers or virtual servers and can operate according to any suitable application or role such as, e.g., an application server, a database server, a file server, or the like.

Storage devices 106 can be any suitable device that device capable of storing or managing data. For instance, a storage device 106 can be a hard disk drive that stores data on spinning disks with magnetic heads, a solid state drive that stores data in non-volatile (e.g., flash) memory devices, a cloud storage device that stores data in remote data centers or cloud-based infrastructure, and so on.

Data services platform 102 can further comprise various other devices or systems such as, for example, network infrastructure (e.g., switches, routers, firewalls, . . . ), data center infrastructure (e.g., power and cooling systems, backup generators, cabling, security devices, . . . ) to support operations, and various management and monitoring systems or tools. One example can be health monitoring system 108.

Generally, health monitoring system 108 can represent any system that collects, processes, or analyzes data from various sources to monitor and track the health of data services platform 102. As illustrated, health monitoring system 108 relies on rules-based engine 112 in order to generate alerts 110. For example, rules-based engine 112 can analyze data collected regarding the operation of data services platform 102 and apply predefined rules to determine whether any issues have occurred. If so, alerts 110 can be generated.

As noted in the Background section, these alerts 110 that are provided to user 112 can enable preemptive measures to be taken in order to mitigate the impact of the issue. However, a number of challenges exist in the context of conventional alert mechanisms. For instance, a common situation often arises in which an overwhelming flood of alerts 110 are generated, often referred to as an alert “burst”. It has been observed that alert bursts can lead to user 112 desensitization, a phenomenon known as “alert fatigue”. Alert fatigue can subsequently lead to missed or delayed responses.

For example, consider an alert burst comprising hundreds of alerts 110 in which all or most of alerts 110 relate to non-critical issues, with only one or a small number relating to critical issues, which can often be missed due to alert fatigue. Furthermore, alert bursts often fail to account for time correlations across the sequence of alerts 110, thereby missing opportunities to enhance the context of various alerts 110.

Another potential shortcoming of existing systems can relate to interpretability. For instance, alert messages 110 are frequently verbose and difficult to decipher without specialized domain knowledge. Hence, even in the face of a verbose alert message, such can be misunderstood or uninformative, which can further delay a response.

Still another potential shortcoming of existing systems can relate to relevance. For instance, many alert mechanisms lack consideration for the contextual system state, leading to alerts that fail to pinpoint the root cause of an impending failure or other issue.

In order to address many of the challenges associated with alert mechanisms, the disclosed subject matter, in some embodiments, is directed to integrating a natural language interface into existing alert mechanisms. This new interface (e.g., a prompt builder) can include or otherwise leverage various artificial intelligence (AI) models such as natural language models (e.g., a large language model (LLM)) to improve readability and understanding of alerts 110 and can also harness retrieval augmented generation (RAG) models to improve relevance and context information associated with alerts 110.

In addition, the new interface can comprise a prompt builder that can contextualize prompts (e.g., data that are to be input to the AI models) within the time domain. Such can operate to identify correlations with other relevant events and can thus generate more informative and concise alerts.

Certain advantageous results of the disclosed techniques can be to reduce alert volume by temporal prompt chaining. For instance, by employing prompt chaining within a defined time window, the alert mechanism can consider longer contextual spans, summarizing incidents, and reducing the issuance of redundant alerts within a constraint user-defined time window.

Another potential advantage of the disclosed techniques can be improved interpretability through LLM generated alerts. For example, presenting alert messages in natural language can improve the understanding and interpretability for most users 112, which can facilitate more timely and efficient responses to alert messages.

Still another potential advantage of the disclosed techniques can be improved relevance from contextual data. For instance, attention to broader system state contexts can enable the disclosed subject matter to filter out irrelevant information, resulting in more informative alert messages. The new interface disclosed herein can operate as a specialized alert mechanism that can decrease reaction time to alerts, reduce effort expended on root cause analysis, and enhance the overall availability of supported applications or systems.

In that regard, the disclosed subject matter, in some embodiments, can be specifically directed to improved techniques for presenting alert messages in natural language, advantageously in a manner that incorporates the time dimension. Many existing alert mechanisms suffer from verbosity and a lack of contextual information, which can hinder their effectiveness in addressing imminent system failures. To overcome these challenges, the disclosed techniques take advantage of recent advancements in LLM and RAG models, which can be modified to facilitate the capture of time correlations accurately.

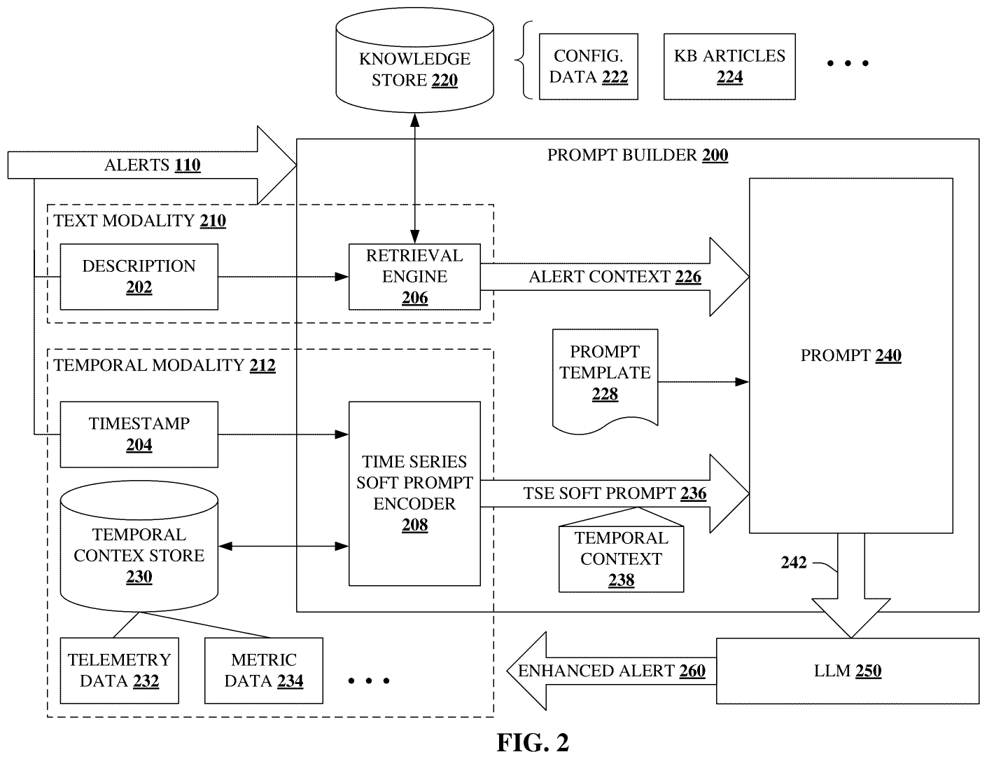

In that regard, it is understood that LLM and RAG models are designed to operate in a text-based modality. For example, both the input to and output from an LLM is natural language text. However, telemetry data or metric data is typically stored according to a time-based modality (e.g., time series data) that is not consistent with the text-based modality of LLM, which is further detailed with reference to FIG. 2 and subsequent FIGS.

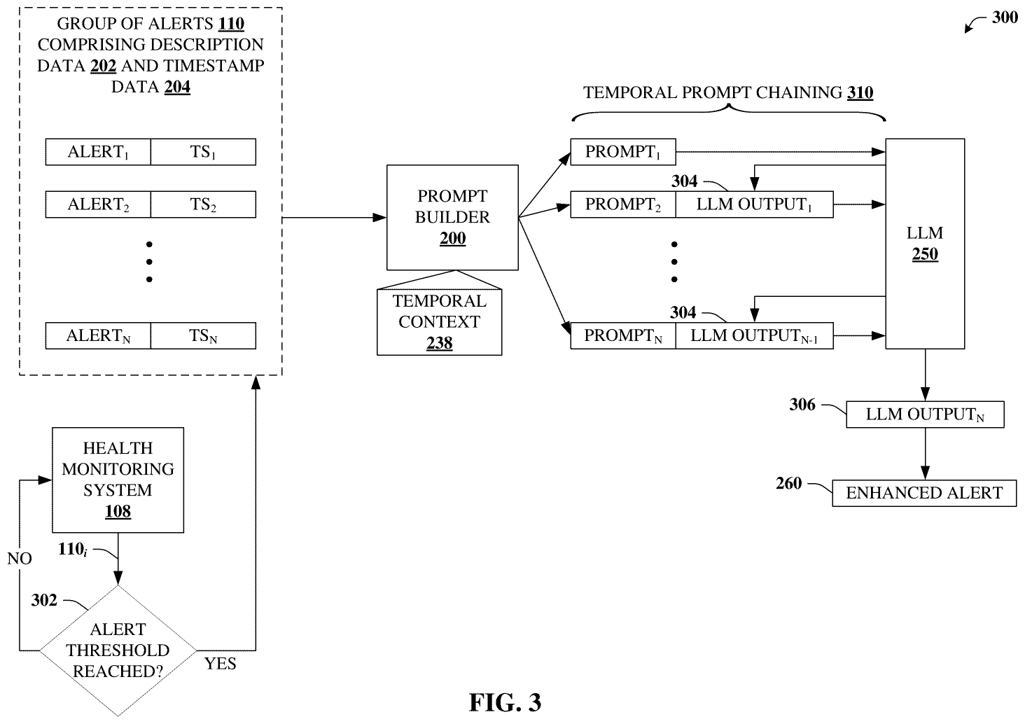

To bridge the divide between the structured nature of system metrics and/or telemetry data, which are typically depicted as time series data, and the user-friendly interface of natural language alerts, the disclosed subject matter introduces temporal prompt chaining (TPC), which is further detailed with respect to FIG. 3 and subsequent FIGS. TPC can operate to seamlessly integrate relevant timestamps and associated metric data as time series during the prompt chaining process used to generate responses from RAG models. As a result, the alert mechanism can operate in a manner that is dynamic, contextually aware, and capable of supporting proactive system maintenance efforts.

In essence, this approach can revolutionize the way alert messages are formulated and delivered, ensuring that the alert messages provide timely, actionable insights while also being user-friendly and comprehensible. To these and other related ends, the disclosed subject matter can be described in more detail with reference to FIGS. 2 and 3, which are directed to respectively illustrating two conceptually distinct aspects of the prompt builder device. In that regard, FIG. 2 illustrates concepts directed to embedding temporal context (e.g., derived from time series data or the like) into a prompt for an AI model that is configured to operate in the context of a text-based modality. FIG. 3 illustrates concepts directed to including the temporal context into existing prompt chaining techniques.

### Example Systems

Initially, FIGS. 2 and 3 are intended to be referenced together. With reference to FIG. 2, a schematic block diagram is depicted illustrating an example prompt builder 200 that can encode temporal context into a prompt associated with a natural language AI model in accordance with certain embodiments of this disclosure. FIG. 3 depicts a schematic block diagram 300 illustrating temporal prompt chaining that integrates the temporal context in accordance with certain embodiments of this disclosure.

In some embodiments, prompt builder 200 can operate as an interface or intermediary between some alert system (e.g., health monitoring system 108) and users 112. For example, prompt builder 200 can receive alerts 110, but rather than presenting alerts 110 to user 112, prompt builder 200 can instead present enhanced alert 260 to user 112. As specifically illustrated in connection with decision block 302 of FIG. 3, in some embodiments, a sequence or group of alerts 110 can be received in response to an alert threshold being reached. For example, the alert threshold can represent a defined number of alerts 110 being generated by health monitoring system 108 within a defined time window.

Regardless, a given alert 110 generated by an existing rules-based system can comprise a description 202 portion, referred to herein as alertᵢ or aᵢ, and a timestamp 204 portion referred to herein as Tᵢ. Hence, given a sequence of alerts (aᵢ) along with associated timestamps {(aᵢ, Tᵢ):i∈1.. N}, one objective can be to generate an alert message M (e.g., enhanced alert 260) in natural language in a manner that accurately reflects the current state of the system being monitored (e.g., data services platform 102). In accordance with the disclosed techniques, such can be achieved by leveraging the correlations between the relevant timestamps Tᵢ and various sources of contextual information, including system configurations, telemetry metric data, types of alerts, and more.

As illustrated, description 202 is typically text and therefore is considered as data in a text modality 210, whereas timestamp 204 can be considered as data in a temporal modality 212. Thus, prompt builder 200 can handle these two distinct data elements in different ways. For example, description 202 can be provided to retrieval engine 206 that typically operates in text modality 210. Retrieval engine 206 (e.g., a RAG model) can use description 202 to search knowledge store 220. Knowledge store 220 can comprise, for example, system configuration data 222, knowledge base articles 224, and so on. In response, retrieval engine 206 can determine and/or generate alert context 226, which can indicate additional context information regarding a given alert 110ᵢ.

In contrast, timestamp 204 can be provided to time series soft prompt encoder 208 that typically operates in temporal modality 212. Time series soft prompt encoder 208 can use timestamp 204 to search temporal context store 230. Unlike knowledge store 220, which is typically organized according to text modality 210, temporal context store 230 can be organized according to temporal modality 212. For example, temporal context store 230 can comprise telemetry data 232, metric data 234, and so on. It is to be understood that information stored according to a temporal modality 212 (e.g., time series data) is not typically suitable for input to natural language AI processing models such as a RAG model or an LLM

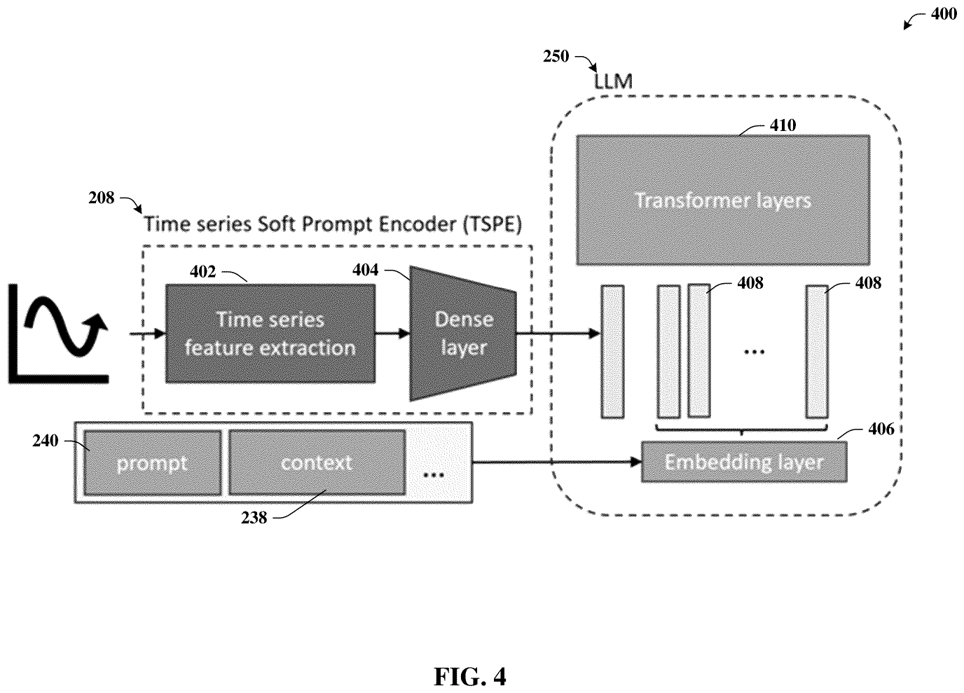

Thus, in response, time series soft prompt encoder 208 can determine and/or generate time series encoded soft prompt 236, which can incorporate temporal context 238 regarding a given alert 110i, which is further detailed in connection with FIG. 4. Hence, as illustrated, prompt 240 (e.g., an input that is suitable for LLM 250 or another suitable natural language AI model) can be generated, potentially by leveraging prompt template 228. Prompt 240 can be based on both alert context 226 and time series encoded soft prompt 236. As illustrated at reference numeral 242, prompt 240 can be input to LLM 250 in order to generate enhanced alert 260.

Thus, an example overall architecture can rely on temporal context 238 embedding (e.g., as illustrated in connection with FIG. 2) and temporal prompt chaining 310 (e.g., as illustrated in connection with FIG. 3). Such can provide a consolidated and succinct enhanced alert 260 for presentation (e.g., to user 112) instead of presenting standard alerts 110.

As noted, standard alert mechanisms continuously monitor current system parameters with respect to certain thresholds implemented in device-specific rules engines. Typically, once a triggering event occurs in the rules engines, an alert is generated and shown to the user. The disclosed techniques can deviate from this standard workflow and leverage a RAG model to generate enhanced alert messages 260 based on the alerts 110 generated by the rules engine and the corresponding telemetry data 232 (or other temporal context data) to produce a contextual and pertinent enhanced alert messages 260.

Although, RAG models have been demonstrated to generate high quality text content with relevant information primarily in information retrieval and in a natural language domain, certain use cases in connection with the disclosed subject matter poses some unique challenges for which RAG models are yet to be explored thoroughly.

For example, a single alert 110 generated by the rules engine 112 may not have the complete information pertaining to the overall state of the system. In order to capture a consolidated view of the system, the RAG model can benefit by having access to a series of alerts (e.g., alert₁-alert_{N}, wherein N can be any whole number) generated in relatively close in time. An example of such can be the group of alerts 110 illustrated in FIG. 3.

Another challenge can be that system metric data 234 (or other temporal context data) that is captured as part of the telemetry signals can contain crucial information relating to the health of the system. While the majority of the configuration data 222 (or other knowledge data) and alert related context information can be adequately expressed in textual form (e.g., text modality 210), metric data lies in time domain (e.g., temporal modality 212). Therefore, the disclosed techniques can operate according to a multimodal scheme combining text and time domains and/or modalities.

To address the above-mentioned challenges, introduced is a prompt chaining technique referred here as temporal prompt chaining (TPC) 310. TPC can utilize a sequence of alerts from an alert queue (e.g., group of alerts 110) and invoke a prompt builder 200 to construct a chain of prompts containing temporal contexts 238 as well as intermediate responses 304 from LLM 250. Prompt builder 200 can consist of the retrieval engine of the RAG architecture (e.g., retrieval engine 206) which has access to a repository of system configuration data as well as knowledge base articles (e.g., knowledge store 220) to retrieve relevant context for a particular alert referred here as the alert context 226. To combine the text modality 210 of the prompts typically accepted by LLMs and the temporal context information in form of time series data in a uniform way, the disclosed techniques can leverage a tunable time series soft prompt encoder (TSPE) 208 module depicted in FIG. 2 and further detailed below in connection with FIG. 4. TSPE 208 module can be configured to learn latent representations of the input metric data that can act as valuable contextual information to the sequence of alerts which are concatenated to the final prompt 240. In some embodiments, the length of the prompt chain (or time window) can be defined as a hyper parameter of the system which can be tuned based on a desired accuracy.

With regard to temporal prompt chaining 310 indicated in FIG. 3, despite achieving remarkable performances in simple information seeking tasks, LLMs are known to struggle with complex search queries. Prompt chaining is a technique to solve a complicated retrieval task through LLMs by breaking the complicated retrieval task down into much smaller subtasks and then reusing the intermediate responses 304 from the LLM in subsequent prompts. Moreover, with the help of the RAG architecture, the response quality can be further improved by providing additional context (e.g., alert context 226) to the individual prompts 240. This additional alert context 226 can be provided by a separate retrieval engine 206 that in response to a prompt (e.g., referred to as “query” in context of information retrieval) retrieves relevant documents from an external data source such as knowledge store 220.

Traditionally, additional context information is assumed to be in the same modality as the prompt itself (e.g., text modality 210). However, in the disclosed use case, at least some portion of potentially important and relevant context lies in time domain in form of telemetry data 232 and/or metric data 234. To bridge the gap between these two modalities, TSPE 208 can be leveraged as detailed above, e.g., to seamlessly combine temporal context 238 with the textual prompt. The final LLM output_{N} 306 can be indicative of enhanced alert 260.

Unlike manually hand-crafted prompts (e.g., hard prompts), soft prompts are machine generated typically with the help of a much smaller deep learning module. Also, the raw text description 202 found in the alerts 110 can be utilized to retrieve relevant textual documents in form of KB articles and configuration information as detailed in order to generate alert context 226, which is distinct from temporal context 238, as explained. Prompt builder 200 can consolidate these different types of context information to form a single prompt 240, which can then be passed on to the subsequent modules of the system such as LLM 250.

With reference now to FIG. 4, a schematic block diagram 400 is depicted illustrating in more detail operation of the time series soft prompt encoder 208 in accordance with certain embodiments of this disclosure. As detailed in connection with FIG. 2, TSPE 208 can operate in temporal modality 212 and can therefore accommodate temporal inputs such as time series data or other data stored in temporal context store 230.

In more detail, TSPE 208 can encode time series input data as an embedding vector, which can then be pre-pended to the embedded prompt vectors acting as a soft prompt. In that regard, TSPE 208 can comprise time series feature extraction (TSFE) 402 element and dense layer 404. TSFE 402 can represent a process that takes raw time series data (e.g., temporal data from temporal context store) and transforms the input into a more manageable and relevant set of features that can be used to train a machine learning model. One goal of feature extractions can be to reduce the amount of redundant data and to highlight information that is determined to be more important or relevant.

Output of TSFE 402 can be input to dense layer 404. Dense layer 404 can be a type of neural network layer that operates to facilitate changing the dimensionality of the output from the preceding layer. For example, dense layer 404 can receive output from “neurons” of the preceding layer and perform matrix-vector multiplication to produce the output.

A large language model such as LLM 250 typically consists of an embedding layer (e.g., embedding layer 406) that can encode tokenized input from a prompt (e.g., prompt 240) into numerical vectors. The embedding layer 406 can comprise embedding vectors 408 that respectively correspond to the existing vocabulary of LLM 250 as initially trained. Soft prompt tuning technique can introduce one or more additional out-of-vocabulary tokens and corresponding embedding vectors 408 output by dense layer 404, which are then passed on to the subsequent layers of the internal transformer architecture (e.g., transformer layers 410) of LLM 250.

In regards to the soft prompt output of TSPE 208, it is to be understood that soft prompts are different than the hard prompt engineer technique for several reasons. For example, unlike hard prompt engineering, the soft prompt tokens are trainable using deep learning optimization techniques such as gradient descent and others. As another example, unlike hard prompts, soft prompts are not necessarily limited to the language domain and can introduce abstract representations such as time series encodings.

For at least the above reasons, the disclosed subject matter can employ soft prompt tuning to combine the time series context with the existing prompt embeddings of LLM 250. Specifically, disclosed techniques can employ a much smaller deep learning module of TSPE 208 that operates in multiple stages. For example, during a first stage, TSPE 208 (e.g., via TSFE 402) can compute sparse time series features from input time series data. During a second stage, TSPE 208 (e.g., via dense layer 404) can project the feature vectors into a vector space of LLM 250, wherein the projected feature vectors have the same dimensions as LLM embedding vectors 408. The resulting soft token vector can then be concatenated with embedding vectors 408 of LLM 250 and processed through the rest of the transformer layers 410 of LLM 250.

As can be observed, the disclosed techniques can be used to leverage large language models to generate enhanced alert messages 260. This allows the system to be more flexible in communicating only the important information to the user based on the current state of the system and other context information not normally available to existing solutions.

It can be further observed that to capture the current state of the system being monitored, the disclosed techniques advantageously consider series data of alerts generated around the current time through a chain of prompts to the LLM agent while generating the alert message. However, the disclosed techniques can identify that the timestamps associated with the individual alerts that can be key to explore additional contextual information correlated with the alert events and therefore can be advantageous to incorporate into the prompt chain. Based on this insight, the disclosed techniques can implement temporal prompt chaining 310 as a new prompt chain technique that takes the time correlation aspect into account while building the prompt chains.

With regard to time series encoding, while injecting time correlated relevant information may enrich the available context for LLM 250, injecting time correlated relevant information can also introduce additional challenges for encoding any relevant time series data, such as telemetry metric data, into textual prompts. To handle this multimodality, TSPE 208 is introduced, which can employ a deep learning model to project any contextual information captured in time series onto a domain suited for the LLM prompts.

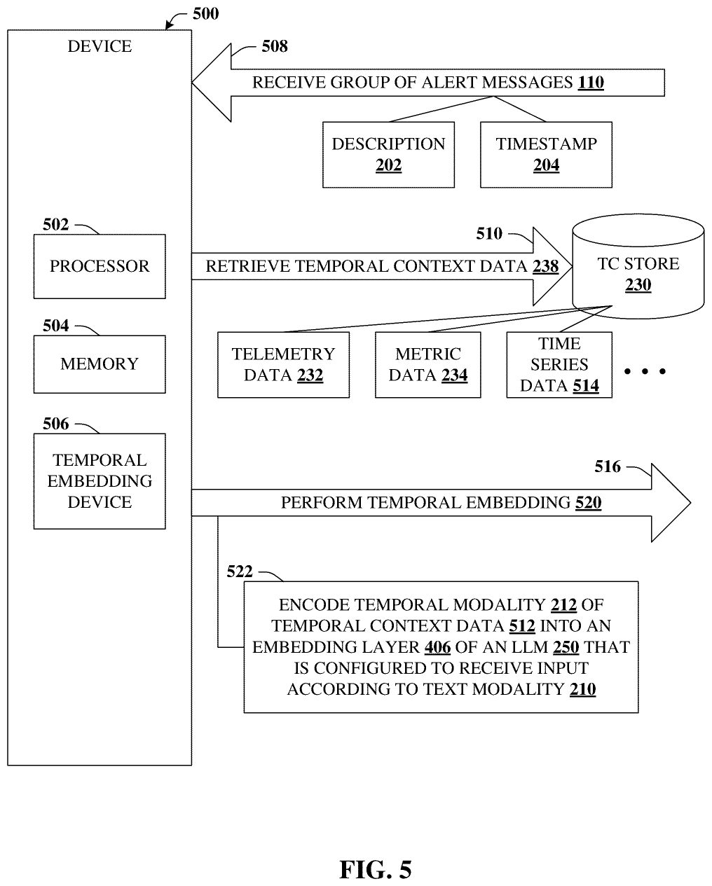

With reference now to FIG. 5, a schematic block diagram illustrating an example device 500 that can perform temporal embedding that encodes temporal context data into an embedding layer of an AI model in accordance with certain embodiments of this disclosure. In that regard, device 500 can be part of a data services platform such as data services platform 102 of FIG. 1. In some embodiments, device 500 can be integrated with or communicatively coupled to a health monitoring system (e.g., health monitoring system 108). In that regard, device 500 can receive or intercept alerts 110. In some embodiments, device 500 can be all or a portion of prompt builder 200 detailed in connection with FIGS. 2-4.

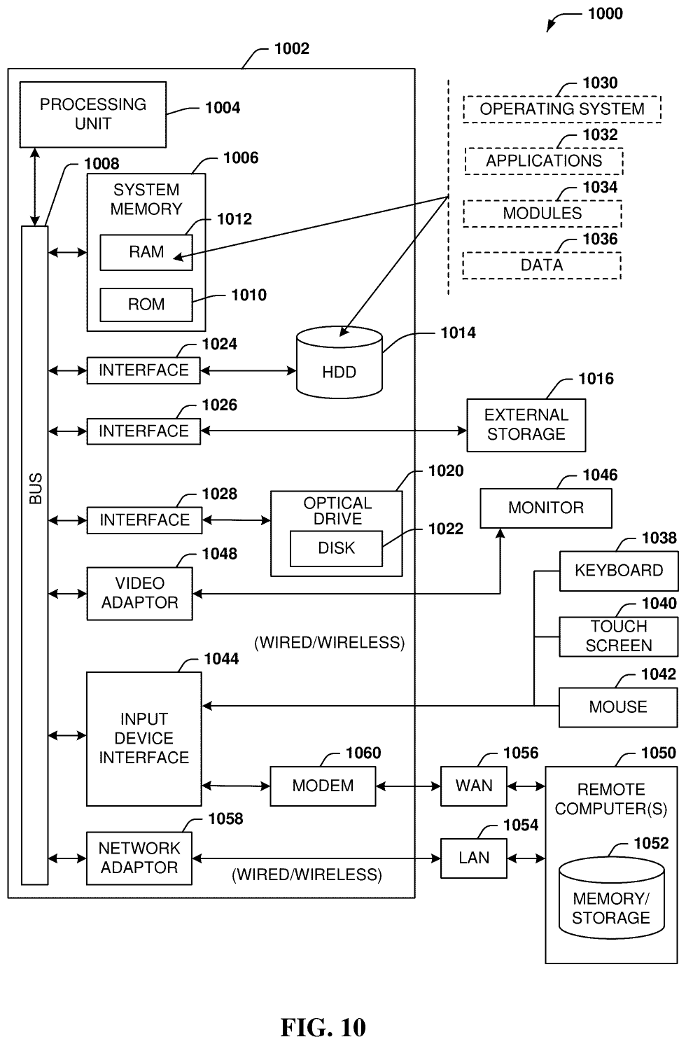

Device 500 can comprise at least one processor 502 that, potentially along with temporal embedding device 506, can be specifically configured to perform functions associated with embedding or encoding temporal context data into an embedding layer of an AI model such as an LLM. Device 500 can also comprise at least one memory 504 that stores executable instructions that, when executed by the at least one processor 502, can facilitate performance of operations. Processor(s) 502 can be a hardware processor having structural elements known to exist in connection with processing units or circuits, with various operations of processor 502 being represented by functional elements shown in the drawings herein that can require special-purpose instructions, for example, stored in memory 504 and/or temporal embedding device 506. Along with these special-purpose instructions, processor 502 and/or temporal embedding device 506 can be a special-purpose device. Further examples of the memory 504 and processor 502 can be found with reference to FIG. 10. It is to be appreciated that device 500 or computer 1002 can represent a server device or a client device of a network or data services platform and computer 1002 can be used in connection with implementing one or more of the systems, devices, or components shown and described in connection with FIG. 5 and other figures disclosed herein.

As illustrated at reference numeral 508, device 500 can receive a group of alert messages such as alert 110 detailed in connection with FIGS. 1 and 3. Respective alert messages 110 can comprise a description 202 of the alert 110 in a text modality and a timestamp 204 indicative of a time at which the alert 110 was generated.

As illustrated at reference numeral 510, based on timestamp 204, device 500 can retrieve temporal context data 238. In some embodiments, temporal context data 238 can be retrieved from a temporal context store such as temporal context store 230. Temporal context store 230 can comprise telemetry data 232, metric data 234, time series data 514, and so forth. As noted, such data can be stored according to temporal modality 212. Hence, temporal context data 238 pertinent to a time window around the time of alert 110 can be acquired. Such can be indicative of significant context data relating to a state of data services platform 102.

At reference numeral 516, device 500 can perform temporal embedding 520. In more detail, at reference numeral 522, device 500 can encode the temporal modality 212 of temporal context data 238 into an embedding layer 406 of the AI model that is configured to receive input according to text modality 210. As a representative example, the AI model can be LLM 250.

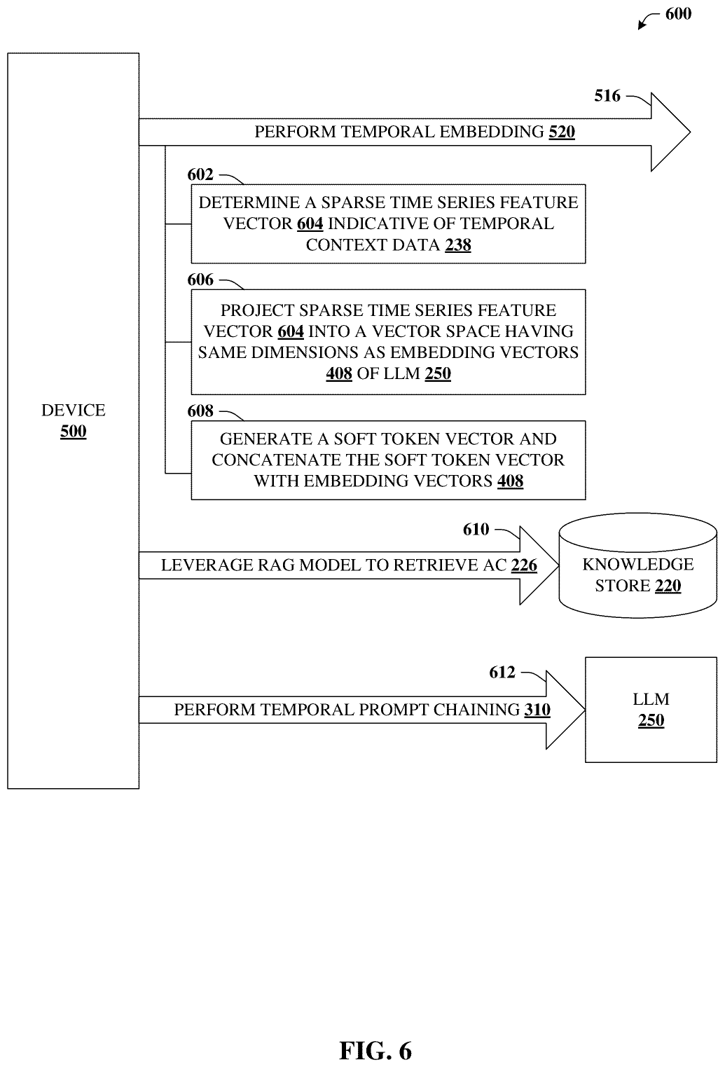

With reference now to FIG. 6, a schematic block diagram 600 is depicted illustrating additional aspects or elements of the example device 500 that can perform temporal embedding that encodes temporal context data into an embedding layer of an AI model in accordance with certain embodiments of this disclosure.

For example, as part of temporal embedding 520 detailed in connection with FIG. 5, at reference numeral 602, device 500 can determine a sparse time series feature vector 604. Sparse time series feature vector 604 can be indicative of temporal context data 238. At reference numeral 604, device 500 can project sparse time series feature vector 604 into a vector space having the same dimensions as embedding vectors 408 of LLM 250. At reference numeral 608, device 500 can generate a soft token vector and concatenate the soft token vector with embedding vectors 408.

At reference numeral 610, device 500 can leverage a RAG model to retrieve alert context 226 data. Alert context 226 data can be retrieved from knowledge store 220 that is typically accessed according to text modality 210. Knowledge store 220 can comprise, for example, system configuration data 222, knowledge base articles 224, and so on.

At reference numeral 612, device 500 can perform temporal prompt chaining 310. As detailed, temporal prompt chaining 310 can relate to decomposing a temporal prompt suitable for input to the AI model (e.g., LLM 250) into a first temporal prompt and a second temporal prompt that utilizes an output of the AI model generated in response to the input of the first temporal prompt as part of the second temporal prompt.

### Example Methods

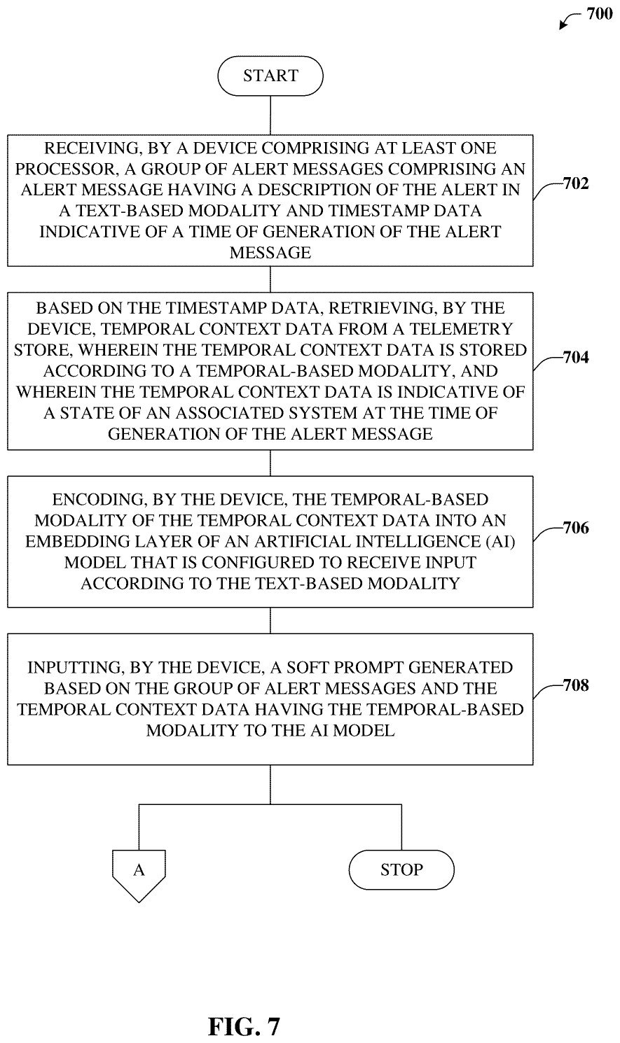

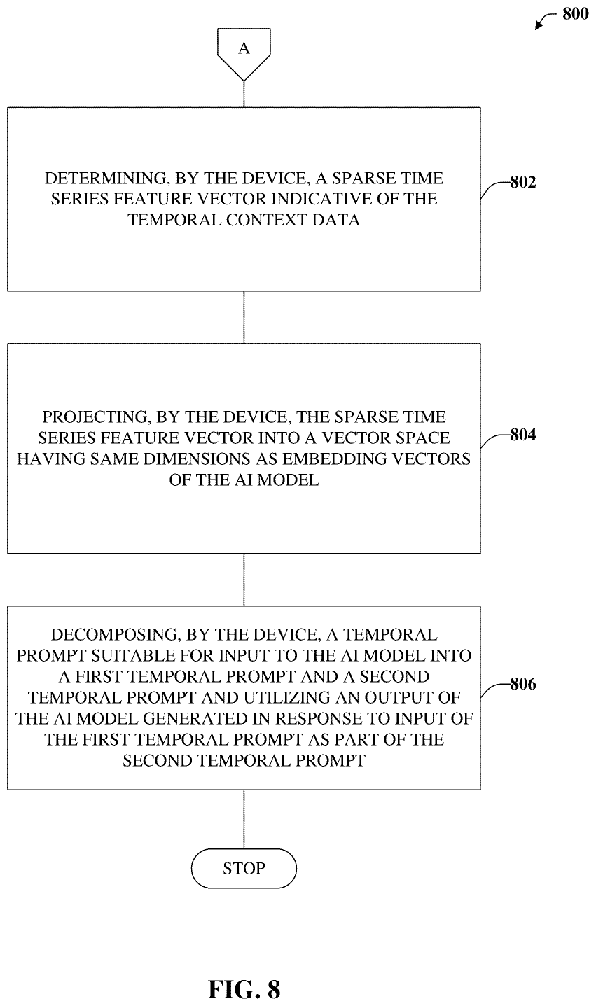

FIGS. 7 and 8 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, exemplary method 700 is depicted. Method 700 can perform temporal embedding that encodes temporal context data into an embedding layer of an AI model in accordance with certain embodiments of this disclosure. While method 700 describes a complete method, in some embodiments, method 700 can include one or more elements of method 800, reached via insert A, as discussed at FIG. 8.

At reference numeral 702, a device comprising at least one processor can receive a group of alert messages. The group of alert messages can comprise an alert message having a description of the alert in a text-based modality and timestamp data indicative of a time of generation of the alert message.

At reference numeral 704, based on the timestamp data, the device can retrieve temporal context data from a telemetry store. The temporal context data can be stored in the telemetry store according to a temporal-based modality such as time series data. The temporal context data can be indicative of a state of an associated system (e.g., data services platform 102) at the time of generation of the alert message.

At reference numeral 706, the device can encode the temporal-based modality of the temporal context data into an embedding layer of an artificial intelligence (AI) model (e.g., LLM 250) that is configured to receive input according to the text-based modality.

At reference numeral 708, the device can input a soft prompt generated based on the group of alert messages and the temporal context data having the temporal-based modality to the AI model. Method 700 can terminate in some embodiments, or in other embodiments proceed to insert A, which is further detailed in connection with FIG. 8.

Turning now to FIG. 8, exemplary method 800 is depicted. Method 800 can provide for additional elements or functionality relating to temporal embedding that encodes temporal context data into an embedding layer of an AI model in accordance with certain embodiments of this disclosure.

For example, at reference numeral 802, the device introduced in connection with FIG. 7 can determine a sparse time series feature vector indicative of the temporal context data. A reference numeral 804, the device can project the sparse time series feature vector into a vector space having same dimensions as embedding vectors of the AI model.

A reference numeral 806, the device can decompose a temporal prompt suitable for input to the AI model into a first temporal prompt and a second temporal prompt and utilizing an output of the AI model generated in response to input of the first temporal prompt as part of the second temporal prompt.

### Example Operating Environments

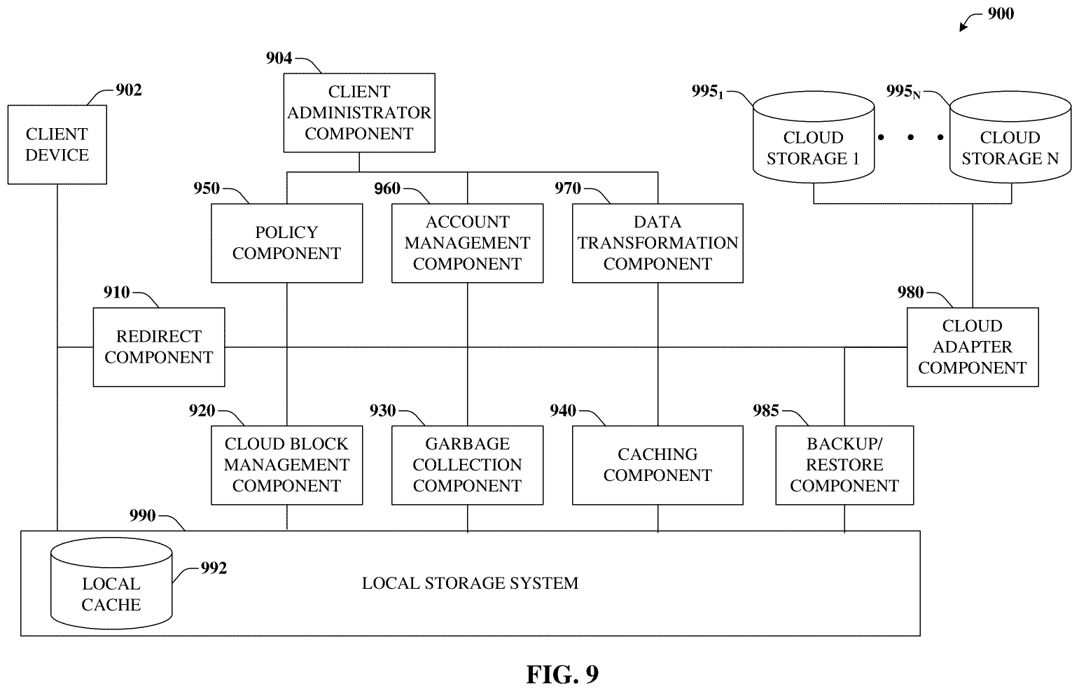

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A device, comprising:
at least one processor; and
at least one memory that stores executable instructions that, when executed by the at least one processor, facilitate performance of operations, comprising:
receiving a group of alert messages comprising an alert message having a description of the alert in a text modality and timestamp data indicative of a time at which the alert message was generated;
based on the timestamp data, retrieving, from a telemetry store, temporal context data that is stored according to a temporal modality, wherein the temporal context data is indicative of a state of an associated system at the time at which the alert message was generated; and
performing a temporal embedding that encodes the temporal modality of the temporal context data into an embedding layer of an artificial intelligence (AI) model that is configured to receive input according to the text modality, wherein the temporal embedding causes the embedding layer to encode temporal vectors and text vectors in a common embedding space to generate an integrated representation.

2. The device of claim 1, wherein the group of alert messages are received from a health monitoring device of the associated system and received in response to a number of alert message in the group being greater than or equal to a defined threshold.

3. The device of claim 1, wherein the temporal context data comprises time series data.

4. The device of claim 1, wherein the AI model is a large language model.

5. The device of claim 1, wherein the temporal embedding further comprises determining a sparse time series feature vector indicative of the temporal context data.

6. The device of claim 5, wherein the temporal embedding further comprises projecting the sparse time series feature vector into the common embedding space having same dimensions as embedding vectors of the AI model.

7. The device of claim 6, wherein the temporal embedding further comprises generating a soft token vector in response to the projecting, and concatenating the soft token vector with the embedding vectors of the AI model.

8. The device of claim 1, wherein the operations further comprise, in response to examination of a knowledge store, determining alert context data that indicates additional context information regarding the alert message.

9. The device of claim 8, wherein the AI model is a first AI model, and wherein the determining the alert context data comprises determining the alert context data based on an output from a second AI model that receives as input information from the knowledge store.

10. The device of claim 9, wherein the second AI model is a retrieval augmented generation model.

11. The device of claim 1, wherein the operations further comprise performing a temporal prompt chaining that decomposes a temporal prompt for input to the AI model into a first temporal prompt and a second temporal prompt that utilizes an output of the AI model generated in response to input of the first temporal prompt as part of the second temporal prompt.

12. A method, comprising:
receiving, by a device comprising at least one processor, a group of alert messages comprising an alert message having a description of the alert in a text-based modality and timestamp data indicative of a time of generation of the alert message;
based on the timestamp data, retrieving, by the device, temporal context data from a telemetry store, wherein the temporal context data is stored according to a temporal-based modality, and wherein the temporal context data is indicative of a state of an associated system at the time of generation of the alert message;
encoding, by the device, the temporal-based modality of the temporal context data into an embedding layer of an artificial intelligence (AI) model that is configured to receive input according to the text-based modality, wherein the encoding causes the embedding layer to process temporal vectors and textual vectors in a common embedding space to generate an integrated representation; and
inputting, by the device, a soft prompt generated based on the group of alert messages and the temporal context data having the temporal-based modality to the AI model.

13. The method of claim 12, further comprising, determining, by the device, a sparse time series feature vector indicative of the temporal context data.

14. The method of claim 13, further comprising, projecting, by the device, the sparse time series feature vector into the common embedding space having same dimensions as embedding vectors of the AI model.

15. The method of claim 12, further comprising, decomposing, by the device, a temporal prompt suitable for input to the AI model into a first temporal prompt and a second temporal prompt and utilizing an output of the AI model generated in response to input of the first temporal prompt as part of the second temporal prompt.

16. A non-transitory computer-readable medium comprising instructions that, in response to execution, cause a system comprising a processor to perform operations, comprising:
receiving a group of alert messages comprising an alert message having a description of the alert in a text modality and timestamp data indicative of a time at which the alert message was generated;
based on the timestamp data indicative of the time at which the alert message was generated, retrieving, from a temporal context store, temporal context data that is stored according to a temporal modality, wherein the temporal context data is indicative of a state of an associated system at the time; and
applying a temporal embedding process comprising encoding the temporal modality of the alert message into an embedding layer of an artificial intelligence (AI) model that is configured to receive input according to the text modality, wherein the temporal embedding causes the embedding layer to process temporal vectors and text vectors in a common embedding space to generate an integrated representation.

17. The non-transitory computer-readable medium of claim 16, wherein applying the temporal embedding procedure further comprises determining a sparse time series feature vector indicative of the temporal context data.

18. The non-transitory computer-readable medium of claim 17,
wherein applying the temporal embedding process further comprises projecting the sparse time series feature vector into the common embedding space having same dimensions as embedding vectors of the AI model.

19. The non-transitory computer-readable medium of claim 18, wherein applying the temporal embedding process further comprises generating a soft token vector in response to the projecting and concatenating the soft token vector with the embedding vectors of the AI model.

20. The non-transitory computer-readable medium of claim 18, wherein the operations further comprise performing a temporal prompt chaining procedure that decomposes a temporal prompt suitable for input to the AI model into a first temporal prompt and a second temporal prompt and utilizes an output of the first AI model generated in response to input of the first temporal prompt as part of the second temporal prompt.
